(19) United States
(12) Patent Application Publication
(10) Pub. No.: US 2020/0279550 A1
(43) Pub. Date: Sep. 3, 2020

(54) VOICE CONVERSION DEVICE, VOICE CONVERSION SYSTEM, AND COMPUTER PROGRAM PRODUCT

(71) Applicant: FUJITSU CLIENT COMPUTING LIMITED, Kanagawa (JP)

(72) Inventor: Yasushi Yabuuchi, Kawasaki (JP)

(73) Assignee: FUJITSU CLIENT COMPUTING LIMITED, Kanagawa (JP)

(21) Appl. No.: 16/745,684

(22) Filed: Jan. 17, 2020

(30) Foreign Application Priority Data
Mar. 1, 2019 (JP) 2019-037889

(51) Int. Cl. G10L 13/08; G10L 13/047; G10L 15/26; G10L 15/22; G10L 15/24; G06K 9/00; G10L 13/04

(52) U.S. Cl. CPC G10L 13/08; G10L 13/047; G10L 15/265; G10L 13/043; G10L 15/24; G06K 9/00302; G10L 15/22

(57) ABSTRACT

A voice conversion device includes: a voice converter that converts an input voice into a voice conversion signal for output; a voice processing unit that performs speech recognition of the input voice in parallel with the voice conversion, and sequentially outputs text data for voice synthesis; a storage that stores therein the text data; an input operation unit that receives designation of the text data and an output instruction; a voice synthesizer that outputs a voice synthesis signal based on the designated text data; and a voice output that outputs a voice based on the voice conversion signal, and outputs a voice based on the voice synthesis signal, in response to the designation of the text data and the output instruction.

### CROSS-REFERENCE TO RELATED APPLICATIONS

This application is based upon and claims the benefit of priority from Japanese Patent Application No. 2019-037889, filed Mar. 1, 2019, the entire contents of which are incorporated herein by reference.

### FIELD

Embodiments described herein relate generally to a voice conversion device, a voice conversion system, and a computer program product.

### BACKGROUND

In conversation, voice in a noisy location or whisper is difficult to hear due to a relatively lower voice level than ambient sound.

The same applies to conversation on telephones or transceivers due to a lower voice level input to a microphone than ambient sound.

In the case of people who have had the larynx removed, they speak with electro artificial larynx (EL) or esophageal speech without using their vocal cords. Because of this, such people greatly differ in voice quality from people with no speech impairments, so that their speech may sound strange to others, which may cause difficulty with their communication.

In view of this, voice conversion devices, i.e., voice changers are available. Currently, voice changers using a computer can convert the voice of an intended person to the one similar to his or her inherent voice. However, whisper and the voice converted by EL differ from normal voice in tone and timbre, so that it is difficult to improve audibility.

It is beneficial to provide a voice conversion device, a voice conversion system, and a computer program product which enable people with the larynx removed to speak in voice quality similar to that of people with no speech impairments, and improve audibility of their speech.

### SUMMARY

According to one aspect of this disclosure, a voice conversion device includes a voice converter that converts an input voice into a voice conversion signal for output; a voice processing unit that performs speech recognition of the input voice in parallel with the voice conversion, and sequentially outputs text data for voice synthesis; storage that stores therein the text data; an input operation unit that receives designation of the text data and an output instruction; a voice synthesizer that outputs a voice synthesis signal based on the designated text data; and a voice output that outputs a voice based on the voice conversion signal, and outputs a voice based on the voice synthesis signal, in response to the designation of the text data and the output instruction.

### BRIEF DESCRIPTION OF THE DRAWINGS

FIG. 1 is a schematic block diagram of an exemplary configuration of a voice conversion device according to a first embodiment;

FIG. 2 is a schematic explanatory diagram of operation according to the embodiment;

FIG. 3 is a front view of an exemplary exterior of the voice conversion device; and

FIG. 4 is a schematic block diagram of an exemplary configuration of a voice conversion system according to a second embodiment.

### DETAILED DESCRIPTION

Embodiments of a voice conversion device and an voice conversion system will be described below with reference to the accompanying drawings. The following embodiments are merely exemplary and not intended to exclude various modifications and application of various techniques not explicitly described in the embodiments. In other words, the embodiments may be modified in various manners without departing from the spirit of thereof. The devices and the system illustrated in accompanying drawings can include other functions in addition to the elements illustrated therein.

### First Embodiment

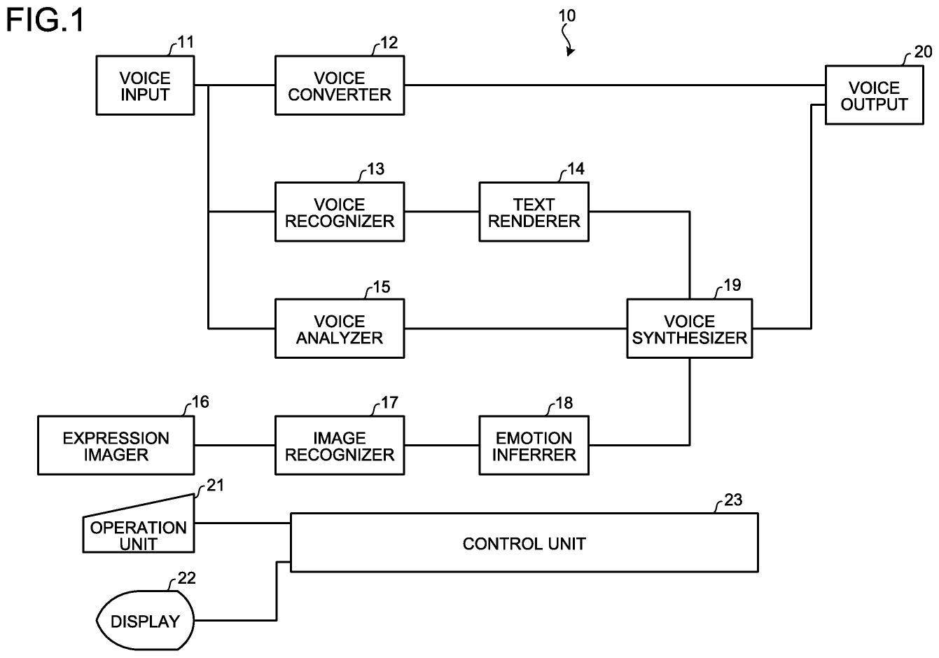

FIG. 1 is a schematic block diagram of an exemplary configuration a voice conversion device according to a first embodiment.

A voice conversion device 10 includes a voice input 11, a voice converter 12, a voice recognizer 13, a text renderer 14, a voice analyzer 15, an expression imager 16, an image recognizer 17, an emotion inferrer 18, a voice synthesizer 19, a voice output 20, an operation unit 21, a display 22, and a control unit 23.

The voice conversion device 10 includes a control unit such as a central processing unit (CPU) or one or more processors, a storage such as read-only memory (ROM) and random-access memory (RAM), an external storage such as a solid-state drive (SSD), a display, and an input device such as a touch panel and a mechanical button. The voice conversion device 10 thus has a hardware configuration including a general computer. The functions of the respective elements (means) as above are implemented by execution of a computer program on the hardware.

The voice input 11 includes a microphone and a microphone amplifier, and converts an input voice (voice generated by electro artificial larynx (EL), for example) of a user being a speaker into an input voice signal for output.

The voice converter 12 converts a voice corresponding to the input voice signal in terms of tone and formant and outputs a voice conversion signal.

The voice recognizer 13 subjects the voice corresponding to the input voice signal to speech recognition and outputs the speech recognition data.

The text renderer 14 converts the voice into text on the basis of speech recognition data, and stores therein the text as text data.

The voice analyzer 15 analyzes the voice corresponding to the input voice signal in terms of speed, tone, and magnitude, for example, and generates and outputs a first voice-synthesis parameter.

The expression imager 16 includes a camera to generate and output an image, such as a face image, including an image from which an expression of the user being a speaker is inferable.

The image recognizer 17 subjects the input image to image recognition to extract images of the parts such as the eyes or the mouth necessary for emotion inference.

The emotion inferrer 18 infers emotion as joy, anger, sorrow, and pleasure of the user being a speaker from the image extracted by the image recognizer 17, and generates and outputs a second voice-synthesis parameter on the basis of the inferred emotion.

The voice synthesizer 19 generates, for storage, voice synthesis data from the input text data, and the corresponding first and second voice-synthesis parameters, and performs voice synthesis to the voice synthesis data and outputs a voice synthesis signal.

The voice output 20 outputs a voice or speech based on the voice conversion signal output from the voice converter 12 and the voice synthesis signal output from the voice synthesizer 19.

The operation unit 21 serves as an operation panel including operational elements that the user variously operates, for example. The user performs various operations to the operation panel, including selection of a desired voice output.

The display 22 presents or displays, for the user, various operational information and candidate information on a subject of a voice synthesis output.

The control unit 23 controls the respective elements of the voice conversion device 10 as well as the entire voice conversion device 10.

In the above configuration, the voice converter 12 can output a voice in response to an input voice in real time. However, the voice synthesizer 19 takes a given amount of time to process the input voice, therefore, it slightly delays in outputting a voice in response to the input voice. The operation of the embodiment will be described next. The general operation of the embodiment will be described first.

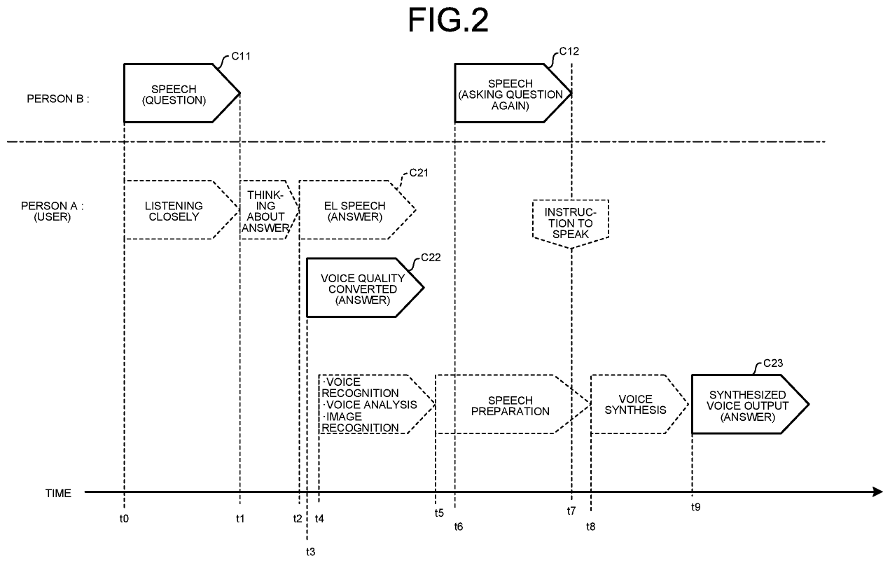

FIG. 2 is a schematic explanatory diagram of the operation according to the embodiment.

The following describes an example that a person A being a user of the voice conversion device and the EL speaks with a person B, for ease of understanding.

The person B starts speaking from time t0 and asks a question C11 (“Is this XX?”, for example) for the period until time t1. The person A listens closely to what the person B says for the duration.

The person A thinks about an answer from the time t1, and speaks with the EL from time t2 to output a voice C21 (“That's XX.”, for example). The voice conversion device 10 functions as voice input means and processes input voice. The voice conversion device 10 generates and outputs a converted voice C22 (“That's XX.” in the example above) in real time from time t3.

In parallel with the output of the voice C22 through voice conversion, the voice conversion device 10 functions as speech recognition means, voice analysis means, and image recognition means, to perform speech recognition, voice analysis, and image recognition from time t4. The voice conversion device 10 also functions as text rendering means and voice analysis means to prepare speech from time t5.

In the speech preparation process, the voice conversion device 10 prepares for voice synthesis, such as conversion of the input voice into text and adjustment of various parameters for use in voice synthesis in terms of pitch, speed, and magnitude of the voice.

At time t6, the person B fails to catch the answer by the voice C21 or the voice C22 and thus asks the same question C12 made at the time t0 again. In this case, at time t7, the person B instructs the voice conversion device 10 to issue a speech through voice synthesis, and then the voice conversion device 10 functions as voice synthesis means to start synthesizing voice at time t8 after completion of the speech preparation, and outputs synthesized voice C23 from time t9.

As configured above, the voice conversion device 10 constantly performs voice synthesis processing, to allow the person A and the person B to communicate with each other by the voice C21 or the voice C22 and have a conversion in real time. If the person A is asked to repeat what he or she has said, the person A uses the voice conversion device 10 to output the synthesized voice C23, improving the audibility of his or her speech.

Thus, the user speaks by synthesized-voice output depending on necessity or when having ample time, to be able to smoothly communicate with others and have complicated conversations. At the same time, the voice conversion device 10 can ensure real-time conversation in the case of speech involving great urgency, such as a danger avoidance request.

Furthermore, the voice conversion device 10 can perform auxiliary operations, such as mechanical operation, translation, information presentation or information retrieval, on the basis of a result of the speech recognition, and can provide enhanced communications.

Specific operation of the first embodiment will be described next.

When the user starts speaking using the EL, for example, the voice input 11 of the voice conversion device 10 converts an input voice of the user into an input voice signal, and outputs the resultant signal to the voice converter 12, the voice recognizer 13, and the voice analyzer 15.

Thus, the voice converter 12 converts a voice corresponding to the input voice signal in terms of tone and formant and outputs a voice conversion signal to the voice output 20 in real time.

As a result, the voice output 20 outputs a converted voice.

In parallel with this operation, the voice recognizer 13 starts recognition of the voice corresponding to the input voice signal, and outputs speech recognition data as a result of the speech recognition to the text renderer 14.

The text renderer 14 converts the voice based on the input speech recognition data into text, and stores therein the text as text data together with time stamp representing input timing of the input voice signal.

In parallel with the processing performed by the voice recognizer 13, the voice analyzer 15 analyzes the voice corresponding to the input voice signal in terms of speed, tone, and magnitude, and generates a first voice-synthesis parameter, which serves as a basic voice-synthesis parameter, such as speech rate, tone, and speech volume, and outputs the parameter to the voice synthesizer 19 together with the time stamp representing the input timing of the input voice signal.

Meanwhile, the camera of the expression imager 16 generates an image including a face image of the user being a speaker, and outputs the image to the image recognizer 17 together with time stamp representing timing at which the image is generated.

The image recognizer 17 subjects the input image to image recognition, extracts images of the parts such as the eyes and the mouth necessary for emotion inference, and outputs the images to the emotion inferrer 18.

Consequently, the emotion inferrer 18 infers emotion as joy, anger, sorrow, and pleasure of the user being a speaker and a subject of imaging from the image extracted by the image recognizer 17, generates a second voice-synthesis parameter on the basis of the inferred emotion, and outputs the parameter to the voice synthesizer 19 together with the time stamp representing the timing at which the corresponding image is generated. The second voice-synthesis parameter serves as a voice-synthesis correction parameter for voice quality associated with emotions, speech rate, and speech volume, for example.

The voice synthesizer 19 acquires the input text data, and the first voice-synthesis parameter and the second voice-synthesis parameter corresponding to the text data, in accordance with the respective time stamps, and generates and stores therein voice synthesis data.

In response to a user's operation to the operation unit 21 to select a desired voice output of an intended person and instruct a voice output, the control unit 23 instructs the voice synthesizer 19 to synthesize the selected voice output.

The selection of a desired voice output of an intended person and the voice output instruction will be described in detail.

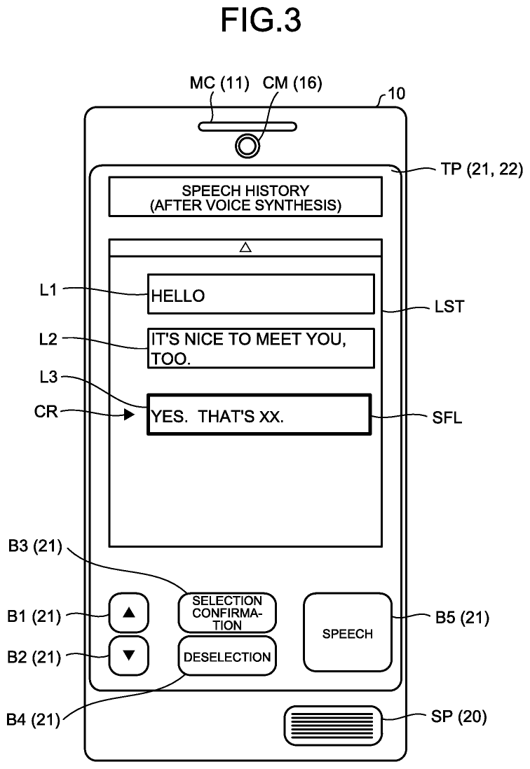

FIG. 3 is a front view of an exemplary exterior of the voice conversion device.

The housing of the voice conversion device 10 includes a touch panel display TP that functions as the operation unit 21 and the display 22, a microphone MC serving as the voice input 11, a camera CM serving as the expression imager 16, and a speaker SP serving as the voice output 20.

In the example of FIG. 3, the touch panel display TP displays, at the top as the display 22, a text information list LST including speech history after voice synthesis, that is, speech history to be ready for voice-synthesis output.

The list LST displays text information L1 “Hello” as a result of a second previous voice synthesis, text information L2 “It's nice to meet you, too.” as a result of a previous voice synthesis, and text information L3 “Yes. That's YY.” as a result of a current voice synthesis.

The list LST further displays a selection mark CR (represented by a right-pointing black triangle in the drawing) and a selection frame SFL (represented by a thick line frame in the drawing) to indicate that the text information L3 is the currently selected voice-synthesis result.

In the example of FIG. 3, the touch panel display TP displays, at the bottom, operation buttons B1 to B5 serving as an operation unit operable by touch.

The operation button B1 is an operator to move the selection mark CR and the selection frame SFL upward on the list LST.

The operation button B2 is an operator to move the selection mark CR and the selection frame SFL downward on the list LST.

The operation button B3 is an operator functioning as a selection confirming button to confirm selected text information indicated by the selection mark CR and the selection frame SFL, as a subject of voice synthesis.

The operation button B4 is an operator functioning as a deselection button to deselect the text information indicated by the selection mark CR and the selection frame SFL from the subject of voice synthesis.

The operation button B5 is an operator functioning as a speech button for instructing the device to synthesize the voice based on the text information indicated by the selection mark CR and the selection frame SFL and output speech.

That is, the user operates the operation button B1 and the operation button B2 on the list LST to display the selection mark CR and the selection frame SFL at the position of desired text information. Then, the user presses the operation button B3 being the selection confirming button and the operation button B5 being the speech button. Thereby, the voice synthesizer 19 synthesizes voice based on voice synthesis data selected (“Yes. That is XX.” in the example of FIG. 3) and outputs a voice synthesis signal to the voice output 20.

Thus, the voice output 20 outputs a voice or speech based on the voice synthesis signal output from the voice synthesizer 19.

As described above, the voice conversion device according to the first embodiment constantly performs necessary processing for voice synthesis while converting voice in real time. If the user can communicate with the other party without difficulty through the real-time speech, the voice conversion device does not perform voice synthesis. This enables the user to have a conversation quickly. When asked to repeat what the user has spoken, the user can speak using the voice synthesis, improving audibility.

Thus, the voice conversion device enables the user to use the synthesized-voice output during conversation depending on necessity or when having ample time. Thereby, the voice conversion device enables the user to improve understanding with others through conversations without delay in communication.

### Second Embodiment

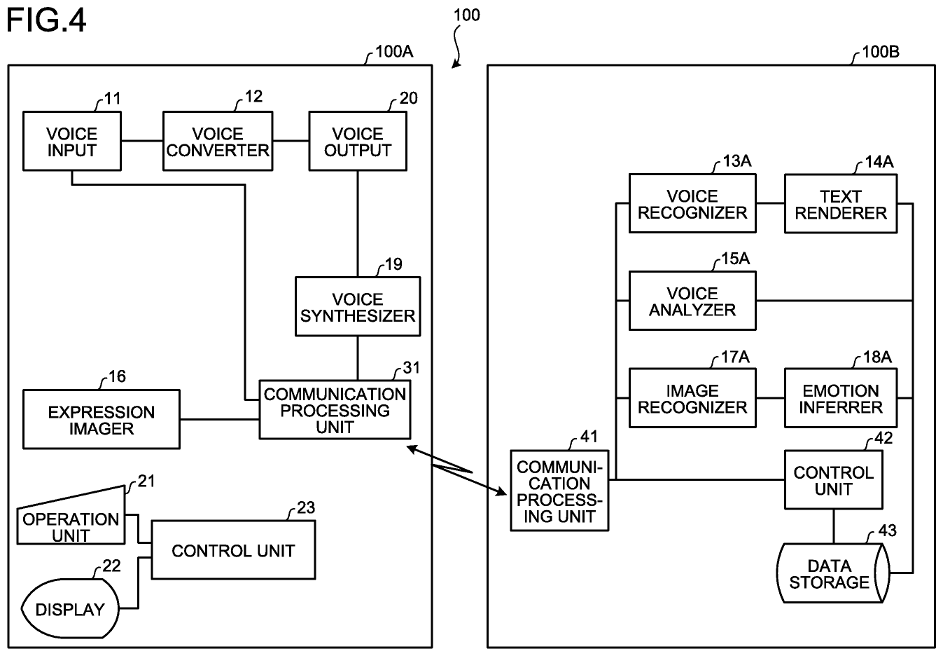

FIG. 4 is a schematic configuration block diagram of a voice conversion system according to a second embodiment. In FIG. 4, the same elements as those in FIG. 1 are denoted by the same reference numerals.

A voice conversion system 100 includes a voice conversion device 100A and a voice conversion server 100B connected to the voice conversion device 100A by way of a communication network.

The voice conversion device 100A includes a voice input 11, a voice converter 12, an expression imager 16, a voice synthesizer 19, a voice output 20, an operation unit 21, a display 22, a control unit 23, and a communication processing unit 31.

The voice input 11, the voice converter 12, the expression imager 16, the voice synthesizer 19, the voice output 20, the operation unit 21, the display 22, and the control unit 23 are identical to those in the first embodiment, therefore, a detailed description is omitted.

The communication processing unit 31 of the voice conversion device 100A subjects an input voice signal from the voice input 11 to analog-to-digital conversion and transmits input voice data to the voice conversion server 100B. The communication processing unit 31 receives image data from the expression imager 16 and transmits the image data to the voice conversion server 100B, and receives and transmits voice synthesis data from the voice conversion server 100B to the voice synthesizer 19.

The voice conversion server 100B includes a voice recognizer 13A as speech recognition means, a text renderer 14A as text rendering means, a voice analyzer 15A as voice analysis means, an image recognizer 17A as image recognition means, an emotion inferrer 18A, a communication processing unit 41, a control unit 42, and a data storage 43.

The voice conversion device 100A and the voice conversion server (voice processing server) 100B each include a control unit such as a CPU or one or more processors, a storage such as a ROM and a RAM, an external storage such as an SSD and a hard disk drive (HDD), a display, and an input device such as a touch panel, a mechanical button, a keyboard, and a mouse. That is, the voice conversion device 100A and the voice conversion server 100B each have a hardware configuration including a general computer. The functions of the respective elements or means are implemented by execution of a computer program on the hardware.

In the above configuration, the voice recognizer 13A, the text renderer 14A, the voice analyzer 15A, the image recognizer 17A, and the emotion inferrer 18A corresponds to the voice recognizer 13, the text renderer 14, the voice analyzer 15, the image recognizer 17, and the emotion inferrer 18 in the first embodiment. Thus, the voice conversion device 100A and the voice conversion server 100B differ in processing capacity from the voice conversion device of the first embodiment. However, the details of their processing are identical thereto, therefore, a detailed description thereof is omitted.

The communication processing unit 41 of the voice conversion server 100B receives input voice data from the communication processing unit 31 of the voice conversion device 100A and subjects the voice data to digital-to-analog conversion for output to the voice recognizer 13A and the voice analyzer 15A. The communication processing unit 41 outputs a received image to the image recognizer 17A, and transmits voice synthesis data from the data storage 43 to the communication processing unit 31 of the voice conversion device 100A.

The control unit 42 controls the entire voice conversion server 100B. The data storage 43 stores therein voice synthesis data as results of the processing by the text renderer 14A, the voice analyzer 15A, and the emotion inferrer 18A.

The operation of the second embodiment will be described next.

When the user starts speaking using the EL, for example, the voice input 11 of the voice conversion device 100A converts an input voice of the user into an input voice signal, and outputs the resultant signal to the voice converter 12 and the communication processing unit 31.

Thus, the voice converter 12 converts a voice corresponding to the input voice signal in terms of tone and formant, and outputs a voice conversion signal to the voice output 20 in real time.

As a result, the voice output 20 outputs a converted voice.

The camera of the expression imager 16 generates an image including a face image of the user being a speaker, and outputs the image to the communication processing unit 31 together with time stamp representing timing at which the image is generated.

The communication processing unit 31 receives the input voice data of the analog-to-digital converted input voice signal, and transmits the input voice data and image data from the expression imager 16 to the voice conversion server 100B.

Thus, the communication processing unit 41 of the voice conversion server 100B receives and subjects the input voice data from the communication processing unit 31 of the voice conversion device 100A to digital-to-analog conversion and outputs the resultant data as an input voice signal to the voice recognizer 13A and the voice analyzer 15A, and outputs the received image to the image recognizer 17A.

Thus, the voice recognizer 13A starts recognition of the voice corresponding to the input voice signal, and outputs speech recognition data to the text renderer 14A as a result of the speech recognition.

The text renderer 14A converts the voice based on the input speech recognition data into text, and stores the text as text data in the data storage 43, together with time stamp representing input timing of the input voice signal.

In parallel with the processing performed by the voice recognizer 13A, the voice analyzer 15 analyzes the voice corresponding to the input voice signal in terms of speed, tone, and magnitude, for example, and generates a first voice-synthesis parameter, which serves as a basic voice-synthesis parameter such as speech rate, tone, and speech volume, and stores, in the data storage 43, the parameter together with the time stamp representing the input timing of the input voice signal.

The image recognizer 17A subjects the input image to image recognition, extracts images of the parts such as the eyes or the mouth necessary for emotion inference, and outputs the images to the emotion inferrer 18A.

As a result, the emotion inferrer 18A infers emotions as joy, anger, sorrow, and pleasure of the user being a subject of imaging and a speaker, from the image extracted by the image recognizer 17, and generates a second voice-synthesis parameter from the inferred emotion. The second voice-synthesis parameter serves as a voice-synthesis correction parameter for voice quality associated with the emotions, speech rate, and speech volume. The emotion inferrer 18A stores the parameter in the data storage 43 together with the time stamp representing the timing at which the corresponding image is generated.

Thus, the control unit 42 of the voice conversion server 100B notifies the voice conversion device 100A of the text data and the fact that the data being a subject of voice synthesis is stored in the data storage 43 by way of the communication processing unit 41.

As a result, the control unit 23 of the voice conversion device 100A causes the display 22 to display such a screen as illustrated in FIG. 3. In response to a user's operation to the operation unit 21 to select a desired voice output of an intended person and give a voice output instruction, the control unit 23 receives, from the voice conversion server 100B, voice synthesis data designated by the selection (i.e., text data, the first voice-synthesis parameter and the second voice-synthesis parameter for the text data). In the case of ample communications capacity and ample storage capacity of the voice conversion device 100A, it is possible to download in advance all the voice synthesis data onto the voice conversion device 100A.

The voice synthesizer 19 receives the voice synthesis data by way of the communication processing unit 31 and acquires the input text data and the first voice-synthesis parameter and the second voice-synthesis parameter for the text data in accordance with the respective time stamps, performs voice synthesis of the text data, and outputs a voice synthesis signal to the voice output 20.

Thus, the voice output 20 outputs a voice or speech based on the voice synthesis signal output from the voice synthesizer 19.

As described above, the voice conversion system 100 according to the second embodiment can reduce the processing load on the voice conversion device 100A, downsize the device, and reduce manufacturing costs, in addition to the effects of the first embodiment.

The first and second embodiments have described the voice generated using EL as an example of an input voice. However, an input voice can be any voice such as voice generated by esophageal speech and other methods, the voice of people with no speech impairments, including whisper and voice in a noisy environment.

A computer program executed by the voice conversion device of either of the embodiments or the voice processing server of the second embodiment is recorded and provided in an installable executable file format on a semiconductor memory, such as compact disc-read-only memory (CD-ROM), universal serial bus (USB) memory, and a memory card, and computer-readable storage media, such as a digital versatile disc (DVD), for example.

The computer program executed by the voice conversion device of either of the embodiments or the voice processing server of the second embodiment may be stored on a computer connected to a network, such as the Internet, and provided by being downloaded via the network. The computer program executed by the voice conversion device of either of the embodiments or the voice processing server of the second embodiment may also be provided or distributed via a network, such as the Internet.

The computer program executed by either of the embodiments or the voice processing server of the second embodiment may also be preinstalled and provided on a ROM or the like.

A person skilled in the art can implement and manufacture the embodiments according to this disclosure.

Other Aspects of Embodiments

Other aspects of the above embodiments will be further described.

First Aspect

According to a first aspect of the embodiments, a voice conversion device includes a voice converter that converts an input voice into a voice conversion signal for output; a voice processing unit that performs speech recognition of the input voice in parallel with the voice conversion, and sequentially outputs text data for voice synthesis; storage that stores therein the text data; an input operation unit that receives designation of the text data and an output instruction; a voice synthesizer that outputs a voice synthesis signal based on the designated text data; and a voice output that outputs a voice based on the voice conversion signal, and outputs a voice based on the voice synthesis signal, in response to the designation of the text data and the output instruction.

With such a configuration, the voice conversion device constantly performs necessary processing for voice synthesis while converting voice in real time. If the user can communicate with the other party without difficulty through the real-time speech, the voice conversion device does not perform voice synthesis. This enables the user to have a conversation quickly. If the actual user's speech or voice-converted speech is not sufficient to make others understand, for example, the user speaks using the voice synthesis, improving the audibility of his or her speech.

Second Aspect

According to a second aspect of the embodiments, the voice conversion device includes a voice analyzer that analyzes the input voice and outputs a parameter for the voice synthesis to the voice synthesizer.

With such a configuration, the voice conversion device can synthesize voice using a result of the voice analysis to provide more natural speech.

Third Aspect

According to a third aspect of the embodiments, the voice conversion device includes an image recognizer that performs image recognition of an image representing an expression of a person being a speaker of the input voice; and an emotion inferrer that infers emotions from a result of the image recognition, and outputs a second parameter for the voice synthesis to the voice synthesizer.

With such a configuration, the voice conversion device can obtain the state of emotion of the speaker from his or her expression and reflect the emotion in synthesized voice, enabling the speaker to more naturally speak, reflecting his or her emotions.

Fourth Aspect

According to a fourth aspect of the embodiments, the voice conversion device includes a display that displays a plurality of items of text data in list form; and an operation unit with which text data is designated on the display to give a speech instruction.

With such a configuration, the voice conversion device can repeat the same speech or output speech when necessary, which enables the user to communicate with others smoothly.

Fifth Aspect

According to a fifth aspect of the embodiments, a voice conversion system includes a portable terminal device; and a voice processing server connected to the portable terminal device by way of a communication network. The portable terminal device includes a voice converter that converts an input voice into a voice conversion signal for output; a first communication unit that transmits the input voice and receives voice synthesis data from the voice processing server by way of the communication network; and a voice output that outputs a voice based on the voice conversion signal, and outputs a voice based on the voice synthesis data. The voice processing server includes a second communication unit that receives the input voice and transmits the voice synthesis data by way of the communication network; a voice processing unit that performs speech recognition of the received input voice and sequentially outputs text data for voice synthesis; storage that stores therein the text data; and a voice synthesizer that generates the voice synthesis data on the basis of the text data.

With such a configuration, the voice conversion system performs necessary processing for voice synthesis while converting voice in real time. If the user can communicate with the other party without difficulty through the real-time speech, the voice conversion device does not perform voice synthesis. This enables the user to have a conversation quickly. If the actual user's speech or voice-converted speech is not sufficient to make others sufficiently understand, for example, the user speaks using voice synthesis, improving the audibility of his or her speech. In addition, the voice conversion system can reduce the processing load on the portable terminal device, facilitating system construction and operation.

Sixth Aspect

According to a sixth aspect of the embodiments, a computer program product is for a computer to control a voice conversion device that converts an input voice for output, the computer program product including programmed instructions embodied in and stored on a non-transitory computer readable medium. The instructions, when executed by the computer, cause the computer to perform: converting an input voice into a voice conversion signal for output; speech recognition of the input voice in parallel with the voice conversion, and sequentially outputting text data for voice synthesis; storing the text data; receiving designation of the text data and an output instruction; outputting a voice synthesis signal based on the designated text data; and outputting a voice based on the voice conversion signal, and outputting a voice based on the voice synthesis signal, in response to the designation of the text data and the output instruction.

With such a configuration, the instructions enable the computer to constantly perform necessary processing for voice synthesis while converting voice in real time. If the user can communicate with the other party without difficulty through the real-time speech, the computer does not perform voice synthesis. This enables the user to have a conversation quickly. If the actual user's speech or voice-converted speech is not sufficient to make others understand, for example, the user can speak using voice synthesis, improving the audibility of his or her speech.

According to one aspect of this disclosure, the voice conversion device and the voice conversion system can output voice in quality close to that of people with no speech impairments, improving the audibility of the user's speech.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A voice conversion device comprising:
a voice converter that converts an input voice into a voice conversion signal for output;
a voice processing unit that performs speech recognition of the input voice in parallel with the voice conversion, and sequentially outputs text data for voice synthesis;
a storage that stores therein the text data;
an input operation unit that receives designation of the text data and an output instruction;
a voice synthesizer that outputs a voice synthesis signal based on designated text data; and
a voice output that:
outputs a first voice based on the voice conversion signal, and
outputs a second voice based on the voice synthesis signal, in response to the designation of the text data and the output instruction.

2. The voice conversion device according to claim 1, further comprising
a voice analyzer that analyzes the input voice to output a parameter for the voice synthesis to the voice synthesizer.

3. The voice conversion device according to claim 1, further comprising:
an image recognizer that performs image recognition of an image that represents an expression of a speaker of the input voice; and
an emotion inferrer that infers emotions from a result of the image recognition, and outputs a second parameter for the voice synthesis to the voice synthesizer.

4. The voice conversion device according to claim 1, further comprising:
a display that displays a plurality of items of text data in list form; and
an operation unit with which text data is designated on the display to give a speech instruction.

5. A voice conversion system comprising:
a portable terminal device; and
a voice processing server connected to the portable terminal device by way of a communication network, wherein the portable terminal device comprises:
a voice converter that converts an input voice into a voice conversion signal for output;
a first communication unit that transmits the input voice and receives voice synthesis data from the voice processing server by way of the communication network; and
a voice output that outputs a first voice based on the voice conversion signal, and outputs a second voice based on the voice synthesis data, and
the voice processing server comprises:
a second communication unit that receives the input voice and transmits the voice synthesis data by way of the communication network;
a voice processing unit that performs speech recognition of the received input voice and sequentially outputs text data for voice synthesis;
a storage that stores therein the text data; and
a voice synthesizer that generates the voice synthesis data on the basis of the text data.

6. A computer program product for a computer to control a voice conversion device that converts an input voice for output, the computer program product including programmed instructions embodied in and stored on a non-transitory computer readable medium, the instructions, when executed by the computer, cause the computer to:
convert an input voice into a voice conversion signal for output;
perform speech recognition of the input voice in parallel with the voice conversion, and sequentially output text data for voice synthesis;
store the text data;
receive designation of the text data and an output instruction;
output a voice synthesis signal based on the designated text data; and
output a first voice based on the voice conversion signal, and output a second voice based on the voice synthesis signal, in response to the designation of the text data and the output instruction.
